(19) United States
(12) Patent Application Publication
(10) Pub. No.: US 2009/0070214 A1
(43) Pub. Date: Mar. 12, 2009

(54) Three-Dimensional Memory-Based Three-Dimensional Memory Module

(76) Inventor: Guobiao ZHANG, Corvallis, OR (US)

Correspondence Address: GUOBIAO ZHANG, P.O. BOX 6182, STATELINE, NV, 89449-6182, US

(21) Appl. No.: 12/013,415

(22) Filed: Jan. 11, 2008

Related U.S. Application Data
(60) Provisional application No. 60/971,321, filed on Sep. 11, 2007.

(51) Int. Cl. G06F 12/02; G06Q 30/00

(52) U.S. Cl. 705/14; 711/103; 705/1; 711/E12.008

(57) ABSTRACT

Three-dimensional-memory-based three-dimensional memory module (3D²-M²) is a three-dimensional memory module (3D-MM) comprising a plurality of three-dimensional mask-programmable memory (3D-mM) chips. As an ultra-low-cost and ultra-large-capacity memory module, 3D²-M² is suitable for pre-recorded multimedia library (PML), particularly pre-recorded movie library (PmL). By limiting access to PML, its pricing model is more acceptable to consumers.

### CROSS-REFERENCE TO RELATED APPLICATIONS

This application is related to U.S. Provisional Patent Application 60/971,321, “Three-Dimensional Mask-Programmable Memory-Based Three-Dimensional Memory Module”, filed Sep. 11, 2007.

### BACKGROUND

1. Technical Field of the Invention

The present invention relates to the field of integrated circuit packaging, and more particularly to the three-dimensional packaging of three-dimensional memory.

2. Prior Arts

A three-dimensional memory (3D-M) chip comprises a plurality of vertically stacked memory levels. By using 3D-stacking, 3D-M has an increased storage capacity. However, because 3D-stacking is a very demanding manufacturing process, only one-time—and mask-programmable 3D-M's can be mass-produced in the foreseeable future. As a result, 3D-M is primarily used as a pre-recorded memory, whose contents are recorded before customer delivery. As a pre-recorded memory, it is highly desired for 3D-M to store a large amount of multimedia contents, particularly a large number of movies. Here, “a large number of movies” means at least tens of movies, preferably hundreds of movies (including regular movies, TV programs, video games . . . ).

U.S. Pat. Nos. 5,835,396, 6,034,882, 6,385,074 and others disclose various types of 3D-M. FIG. 1A illustrates a typical 3D-M—one-time-programmable 3D-M (3D-OTP) 10. It comprises four memory levels 10a-10d. Each memory level comprises a plurality of word lines (e.g. 12), bit lines (e.g. 14) and memory cells (e.g. 18). Each memory cell 18 further comprises a diode (not shown in the figure) and an antifuse 16. Antifuse 16 comprises a layer of insulating dielectric, which breaks down during programming. It has a high resistance before programming and low resistance after programming. Inter-level dielectric 13 provides electrical separation between memory levels (e.g. 10c, 10d). Memory-level via (e.g. 10av) provides electrical connection between a memory level (e.g. 10a) and the substrate 11. At present, industry generally believes that, among all 3D-M's, 3D-OTP has the greatest commercial potential. For example, all of the products made by Matrix Semiconductor Inc., a major 3D-M developer, are 3D-OTP.

Before shipping, a 3D-M chip is packaged into a 3D-M module. In prior arts, a 3D-M module generally comprises a single 3D-OTP chip and an interface chip. U.S. Pat. No. 6,545,891 discloses such a 3D-M module. As illustrated in FIG. 1B, it is housed in a standard memory package (e.g. CF or SD), which can be easily inserted into or pulled from a mobile device. This 3D-M module 20 comprises a single 3D-M chip 26 and an interface chip 28. The 3D-M chip 26 used in this 3D-M module 20 is preferably a 3D-OTP (see FIG. 7 of the '891 patent). The interface chip 28 converts the 3D-M data into a standard format (e.g. CF or SD), but does not limit access to the 3D-M data. In this 3D-M module 20, the 3D-M chip 26 and the interface chip 28 are placed side-by-side on a substrate 24.

U.S. Pat. No. 6,731,011 discloses another 3D-M module 30. As illustrated in FIG. 1C, this 3D-M module 30 also comprises a 3D-M chip 36 and an interface chip 38. Similar to FIG. 1B, its 3D-M chip 36 is preferably a 3D-OTP (see FIG. 5 of the '011 patent); and its interface chip 38 does not limit access to the 3D-M data. In this 3D-M module 30, the 3D-M chip 36 and the interface chip 38 are vertically stacked on a substrate 34.

The prior-art 3D-M module (20 or 30) prefers 3D-OTP (26 or 36) as its memory chip. However, among all 3D-M's, 3D-OTP has neither the largest storage capacity, nor the lowest storage cost. In fact, mask-programmable 3D-M (3D-mM) excels 3D-OTP in both aspects. Moreover, the prior-art 3D-M module (20 or 30) typically comprises a single 3D-M chip (26 or 36). As a result, the growth potential of its storage capacity is limited. Overall, the prior-art 3D-M module does not have enough storage capacity to store a large number of movies, which require at least 10 GB of storage space.

The prior-art 3D-M module (20 or 30) does not limit access to its pre-recorded contents. Thus, a customer can access any of its pre-recorded contents once receiving it. Accordingly, the average selling price (ASP) of the 3D-M module should include not only its hardware cost, but also the copyright fees of all of its pre-recorded contents. As its storage capacity grows and more contents can be pre-recorded, the ASP of a 3D-M module will become very high. For example, by using the storage-enhancing means disclosed in the present invention (e.g. by using 3D-mM and/or 3D-MM, see FIGS. 9-12), a 3D-M module can store ˜120 movies at the 50 nm node. This means its ASP can easily exceed ˜$1,000, a price too high for most consumers. Moreover, a high ASP is not fair to consumers because they may not want to watch every movie in the 3D-M module.

In order to overcome these drawbacks, the present invention discloses a three-dimensional-memory-based three-dimensional memory module (3D²-M²). 3D²-M² is an ultra-low-cost and ultra-large-capacity memory module whose pricing model is more acceptable to consumers.

### OBJECTS AND ADVANTAGES

It is a principle object of the present invention to provide an ultra-low-cost, ultra-large-capacity memory module whose pricing model is more acceptable to consumers.

It is another object of the present invention to provide an ultra-low-cost, ultra-large-capacity memory module for pre-recorded multimedia library (PML).

It is another object of the present invention to provide an ultra-low-cost, ultra-large-capacity memory module for pre-recorded movie library (PmL), with movie storage cost comparable to DVD.

It is another object of the present invention to provide an ultra-low-cost, ultra-large-capacity memory module with a low average selling price (ASP).

It is another object of the present invention to provide an ultra-low-cost, ultra-large-capacity memory module, where a user just pays for the selected usage(s).

In accordance with these and other objects of the present invention, the present invention discloses a three-dimensional-memory-based three-dimensional memory module (3D²-M²).

### SUMMARY OF THE INVENTION

Three-dimensional-memory-based three-dimensional memory module (3D²-M²) is a three-dimensional memory module (3D-MM) comprising a plurality of three-dimensional mask-programmable memory (3D-mM) chips. Here, 3D means vertical stacking; and 3D² means two 3D-stackings: 3D-stacking of multiple memory levels in a 3D-mM chip; and 3D-stacking of multiple memory chips in a 3D-MM module. Through two 3D-stackings, 3D²-M² becomes an ultra-low-cost and ultra-large-capacity memory module.

Unlike prior arts, 3D²-M² is not based on 3D-OTP, but based on 3D-mM. Because 3D-mM does not require electrical programming, its structure, design and manufacturing are much simpler than 3D-OTP. At the same technology node, 3D-mM has a storage capacity ˜4 times larger, or a storage cost ˜4 times less than 3D-OTP; and these gaps will become even wider with time. With an ultra-low cost and ultra-large capacity, 3D²-M² is suitable for pre-recorded multimedia library (PML), particularly pre-recorded movie library (PmL). For example, a 3D²-M² can store ˜120 movies at the 50 nm node and its movie storage cost (i.e. the average storage cost per movie) could be as low as ˜$0.4. Considering the movie storage cost for DVD is ˜0.2-$0.7, 3D²-M² is an ideal DVD replacement for movie storage.

To make its pricing model more acceptable to consumers, access to the pre-recorded contents in the 3D²-M² should be limited. This is realized by a usage-control (UC) block. With the UC block, a user can just pay for the selected usage(s). Moreover, by distributing the hardware cost into the usage fee(s), 3D²-M² can be obtained at a nominal average selling price (ASP). To reduce usage fee(s), advertisements can be played back during content playback.

### BRIEF DESCRIPTION OF THE DRAWINGS

FIG. 1A illustrates a 3D-OTP used in a prior-art 3D-M module; FIG. 1B illustrates a prior-art 3D-M module; FIG. 1C illustrates another prior-art 3D-M module;

FIG. 2 illustrates a preferred 3D²-M² system;

FIG. 3 is a block diagram of the preferred 3D²-M² system;

FIG. 4 is a cross-sectional view of a preferred 3D²-M²;

FIG. 5 illustrates a preferred distribution model for the preferred 3D²-M² system;

FIGS. 6 and 7 illustrate two preferred access methods for the preferred 3D²-M² system;

FIG. 8 (on drawing sheet #7) is a block diagram of a preferred UC block;

FIGS. 9 and 10 are perspective and z-x cross-sectional views of a preferred offset 3D-MM;

FIG. 11 is a cross-sectional view of a preferred double-sided 3D-MM;

FIG. 12 is a cross-sectional view of a preferred 3D-mM;

FIG. 13 illustrates another preferred 3D²-M² system;

FIG. 14 illustrates a preferred 3D²-M² system with advertisements;

FIG. 15 illustrates a preferred distribution model for the preferred 3D²-M² system with advertisements;

FIG. 16 illustrates a preferred 3D²-M² with updatability.

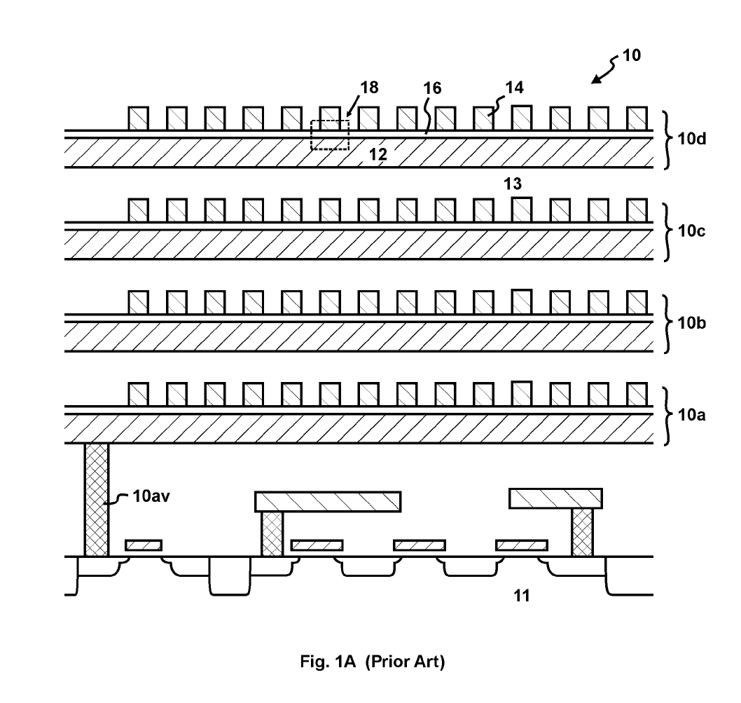

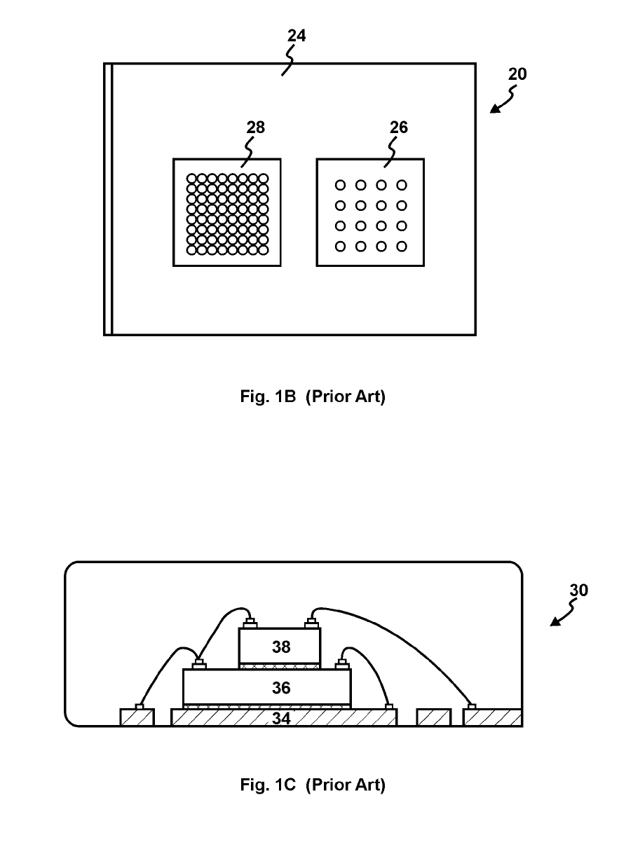

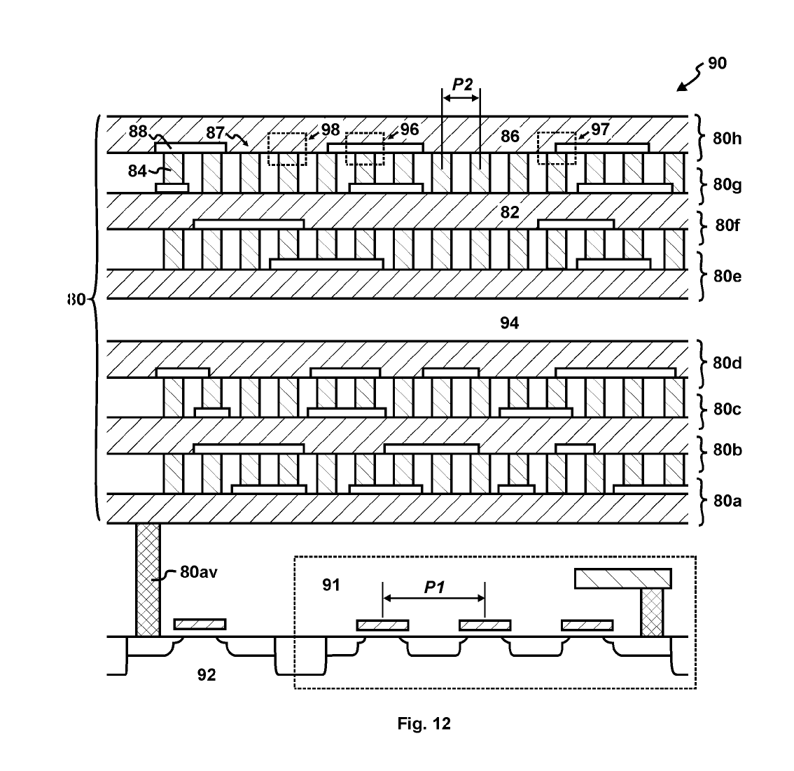

For reason of simplicity, in FIGS. 1A and 12, the diode(s) in the 3D-mM cells is not shown.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

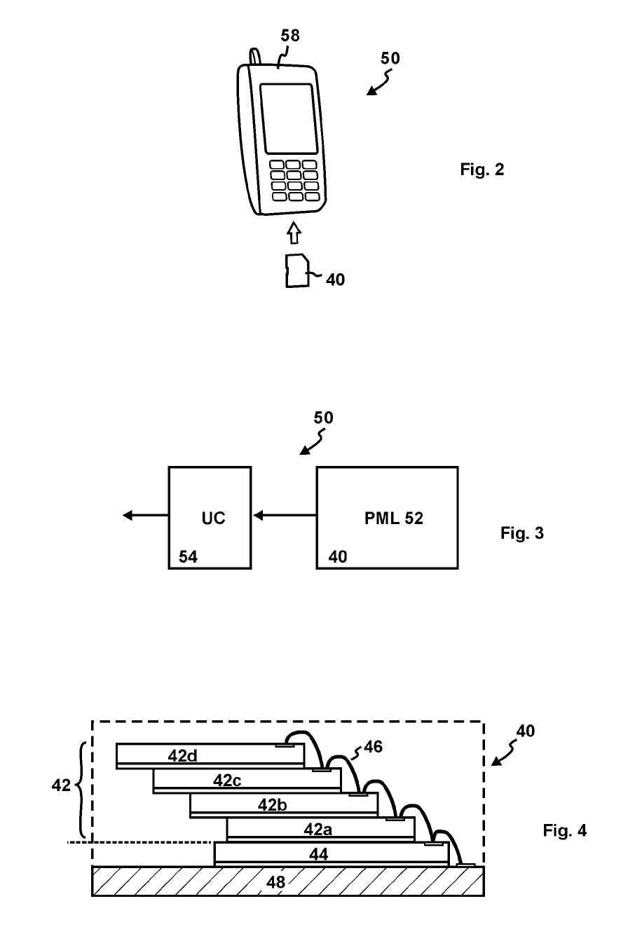

Referring now to FIG. 2, a preferred 3D²-M² system 50 is illustrated. It comprises a mobile device 58 and a 3D²-M² 40. The mobile device 58 plays back the multimedia contents stored in the 3D²-M² 40. It could be a cellular phone, a mobile audio player (e.g. mp3 player), a mobile video player (e.g. mp4 player), a mobile game machine and others. The 3D²-M² 40 stores the multimedia contents to be played by the mobile device 58. It can be inserted into and pulled out from the mobile device 58; or, it can be embedded into the mobile device 58. Besides used on the go, the 3D²-M² 40 can also be used at home or in office.

Referring now to FIG. 3, a block diagram of the preferred 3D²-M² system 50 is disclosed. It comprises the 3D²-M² 40 and a usage-control (UC) block 54. The 3D²-M² 40 contains a pre-recorded multimedia library (PML) 52, which contains a large amount of textual, audio, image, video, game, and/or software contents. One PML of great value is pre-recorded movie library (PmL). A PmL contains not just a small number of movies, but at least tens of movies, preferably hundreds of movies (including regular movies, TV programs, video games . . . ). The UC block 54 controls the usage of the PML 52 and allows a user to just pay for the selected usage(s). It can be located in the 3D²-M² 40 (FIG. 4), or in the mobile device 58 (FIG. 13).

Referring now to FIG. 4, a cross-sectional view of a preferred 3D²-M² 40 is illustrated. It comprises four vertically stacked 3D-mM chips 42a-42d and a UC chip 44. The 3D-mM chips 42a-42d form a 3D-mM stack 42, which is then stacked on top of the UC chip 44. The 3D-mM chips 42a-42d store the PML 52. The UC chip 44 comprises the UC block 54. Bond wires 46 provide electrical connection between chips 42a-42d, 44 and the substrate 48.

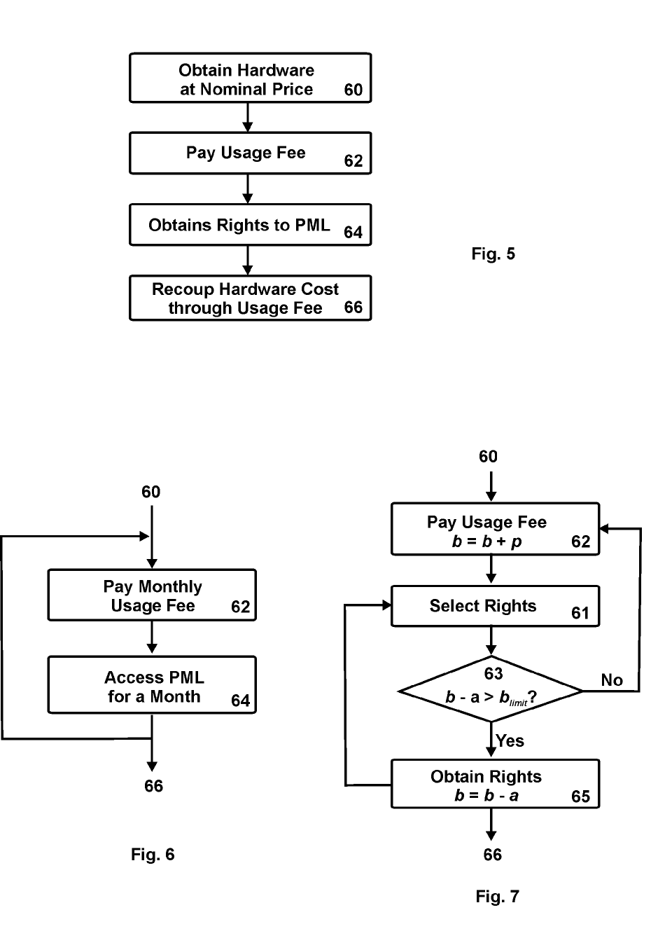

Referring now to FIG. 5, a preferred distribution model for the preferred 3D²-M² system 50 is illustrated. A user first obtains the hardware (e.g. 3D²-M²) (step 60). After paying a usage fee (step 62), the user obtains the desired rights (step 64). Here, payment can be made before usage (like a pre-paid phone card), or after usage (like a credit card). Because the usage fee could include not only the copyright fee, but also a portion of the hardware cost, the hardware manufacturer(s) could recoup the hardware cost through the usage fees (step 66). Accordingly, at the moment of purchase, the user could just pay a nominal average selling price (ASP) for the hardware (e.g. 3D²-M² 40, mobile device 58), or even get the hardware for free (step 60). This can lower the market entry barrier for the 3D²-M² system 50.

Referring now to FIGS. 6 and 7, two preferred access methods for the preferred 3D²-M² system 50 are illustrated. In the first preferred access method of FIG. 6, a user pays a monthly usage fee (step 62), then accesses the PML 52 for a month (step 64). For example, after paying a monthly full-access fee (e.g. $50), a user can watch all movies in the PML 52 within one month; after paying a monthly partial-access fee (e.g. $20), a user can watch 10 movies from the PML 52 within one month.

In the second preferred access method of FIG. 7, the 3D²-M² system 50 keeps record of an account balance (b). This account balance tracks the payment history and the usage history. After the user makes a payment (p), the account balance is credited, i.e. b=b+p (step 62). During usage, the user selects the desired rights (step 61), which require a usage fee (a). As long as the remaining balance (=b−a) is above a threshold bₗᵢₘᵢₜ (step 63), the user can obtain the selected rights and the corresponding usage fee is deducted from the account balance, i.e. b=b−a (step 65).

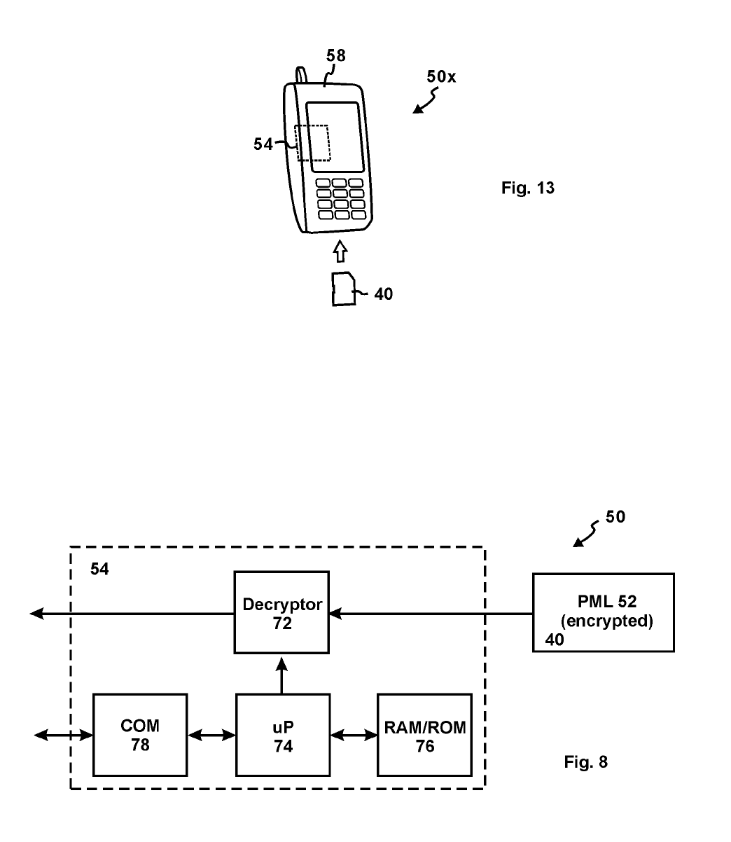

Referring now to FIG. 8 (on drawing sheet #7), a preferred UC block 54 is illustrated. It comprises a micro-processor (uP) 74, a memory (including RAM and ROM) 76, a decryptor 72 and a communication means (COM) 78. To protect copyrights, at least a portion of the PML 52 is encrypted. The decryptor 72 can decrypt the encrypted PML 52 with the encryption key. The ROM 76 stores information such as device ID, account balance, usage fees and encryption keys. The uP 74 determines whether a user has certain rights. If yes, the corresponding encryption key will be sent to the decryptor 72. The 3D²-M² system 50 intermittently communicates with an authorization center through the COM 78, which could be telephone (landline or cellular), internet (wired or wireless), or other means. Cellular phone is particularly convenient because cellular signals have the widest coverage and payment can be directly deducted from a user's cellular account.

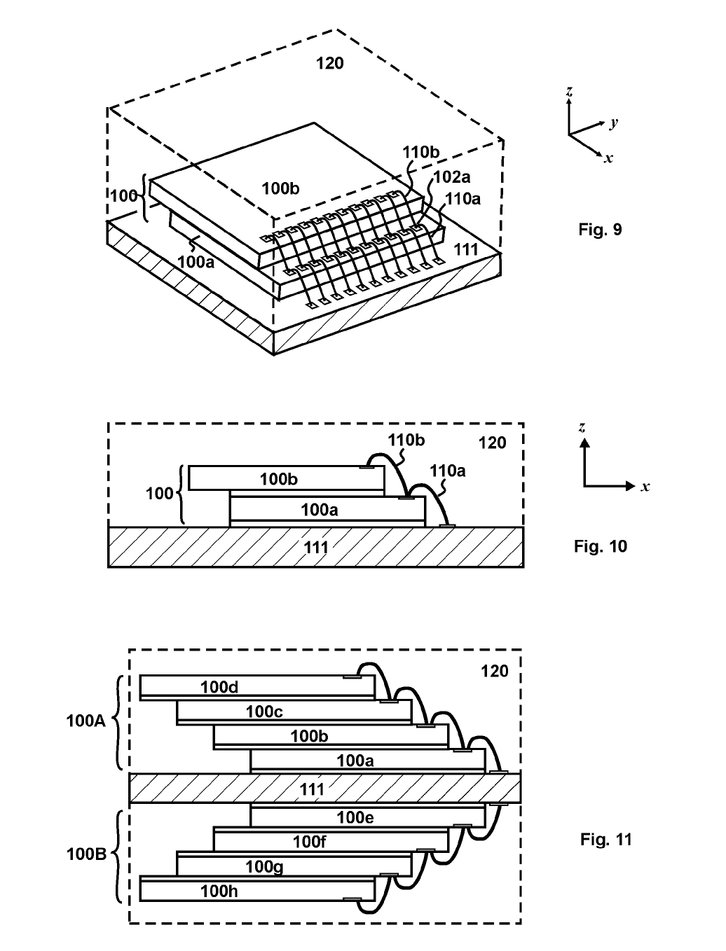

3D-MM is one cornerstone of the 3D²-M². It can significantly increase its storage capacity without significantly increasing its size: by vertically stacking memory chips, its footprint is not much larger than a single chip; by using thinned chips, the height of a ×8 3D-MM (which comprises eight memory chips) could be ˜1.2 mm. FIGS. 9-11 disclose two preferred 3D-MM's—an offset 3D-MM and a double-sided 3D-MM. Other 3D-MM's, e.g. rotated 3D-MM, through-silicon-via-based 3D-MM, chip-in-polymer, package-stacked module, are disclosed in the article “Future ICs Go Vertical”, by P. Garrou, Semiconductor International, February 2005; U.S. Patent Application 60/767,573, “Three-Dimensional Memory Module (3D-MM) Excelling Contemporary Micro-Drive (CMD)”, filed Aug. 30, 2006; and others.

Referring now to FIGS. 9 and 10, a preferred offset 3D-MM is illustrated. It comprises two memory chips 100a, 100b. They are vertically stacked and form a 3D-MM stack 100. The 3D-MM stack 100 is further stacked on top of a substrate 111. The substrate 111 may comprise, for example, a printed circuit board (PCB), a memory card, a lead frame, tape automated bonding (TAB) tape or others. Chip 100b is offset relative to chip 100a in such a way that all contact pads 102a on chip 100a that need electrical connections to chip 100b and substrate 130 are exposed. In this preferred embodiment, the offset is along −x direction. After the offset, chip 100a is connected to chip 100b by bond wire 10b and to substrate 111 by bond wire 10a. The 3D-MM stack 100 is preferably encapsulated in a protective package 120, such as in a molding compound.

Referring now to FIG. 11, a preferred double-sided 3D-MM is illustrated. It comprises eight memory chips 100a-100h. They are grouped into two stacks: 100A and 100B. The stack 100A comprises four chips 100a-100d. They all face upward and are placed on the upper side of the substrate 111. The stack 100B comprises four chips 100e-100h. They all face downward and are placed on the lower side of the substrate 111. This structure is particularly suitable for the 3D-MM comprising a large number of memory chips.

3D-mM is another cornerstone of the 3D²-M². Because it does not require electrical-programming, the structure, design and manufacturing of the 3D-mM are much simpler than 3D-OTP. At the same technology node, 3D-mM has a storage capacity ˜4 times larger, or a storage cost ˜4 times less than 3D-OTP. Moreover, these gaps will become even wider with time.

Referring now to FIG. 12, a preferred 3D-mM 90 is illustrated. It comprises eight memory levels 80a-80h. Each memory level (e.g. 80h) comprises a plurality of word lines (e.g. 84), bit lines (e.g. 86) and 3D-mM cells (e.g. 96, 97, 98). In this preferred embodiment, the 3D-mM cells 96 and 98 store logic “0” and “1”, respectively. They have different structures: at the 3D-mM cell 96, an info-dielectric 88 separates the word line from the bit line; while at the 3D-mM cell 98, the word line is connected with the bit line through an opening 87 in the info-dielectric 88. Here, 3D-mM cell 98 further comprises a diode (not shown). Its electrical resistance is higher when the current flows in one direction than the other.

In the 3D-mM 90, all memory levels (80a-80h) are vertically stacked and form a 3D-mM stack 80, which is further stacked on top of a substrate 92. The memory level (e.g. 80a) and the substrate 92 are coupled through a plurality of memory-level vias (e.g. 80av). Because the 3D-mM cells do not occupy any substrate area, the substrate 92 could be used to form a substrate circuit 91, which can directly process the 3D-mM data. For example, the substrate circuit 91 can be used to realize the UC block 54. In this case, the 3D²-M² 40 of FIG. 4 may not need to comprise a separate UC chip 44.

Because it does not require electrical programming, the 3D-mM 90 can use a simpler peripheral circuit than 3D-OTP. As a result, it has a better array efficiency (i.e. the ratio of the total cell area and the total chip area). Moreover, it can use structures such as N-ary 3D-mM, hybrid-level 3D-mM and small-pitch 3D-mM.

In an N-ary 3D-mM, the 3D-mM cell can have N(N>2) possible states. For example, the memory cells in the 3D-mM 90 can have three possible states. Besides the logic “0” and “1” states, the 3D-mM 90 has a third state, i.e. the 3D-mM cell 97. At this 3D-mM cell 97, the info-dielectric 88 does not completely isolate the word line from the bit line. With more than two states, the 3D-mM 90 supports multi-bit-per-cell. In contrast, because it is difficult to control the antifuse resistance after programming, the 3D-OTP 10 only supports single-bit-per-cell. More details on the N-ary 3D-mM are disclosed in U.S. patent application Ser. No. 11/162,262, “N-ary Mask-Programmable Memory”, filed Sep. 2, 2005.

In a hybrid-level 3D-mM, some memory levels are interleaved, while other memory levels are separated. For example, in the 3D-mM 90, the memory levels 80e-80h are interleaved, i.e. adjacent memory levels (e.g. 80g, 80h) share one level of address-selection lines 84; while the memory levels 80e, 80d are separated by an inter-level dielectric 94. In contrast, to avoid inadvertent programming between memory levels, all memory levels (10a-10d) in the 3D-OTP 10 are separated by an inter-level dielectric 13 (FIG. 1A). This can adversely affect the number of memory levels in the 3D-OTP 10. More details on the hybrid-level 3D-mM are disclosed in U.S. patent application Ser. No. 11/736,767, “Hybrid-Level Three-Dimensional Memory”, filed Apr. 18, 2007.

In a small-pitch 3D-mM, the minimum line pitch (i.e. the center-to-center distance of the adjacent address-selection lines) in the 3D-mM levels is smaller than the minimum gate pitch of the substrate transistors. For example, the minimum line pitch (P2) in the 3D-mM 90 is smaller than the minimum gate pitch (P1). This is because the 3D-mM cell is based on diode, which follows a different scaling rule than transistor. Furthermore, because its memory cells do not comprise antifuse, the scaling of 3D-mM is much faster than 3D-OTP. More details on the small-pitch 3D-mM are disclosed in U.S. patent application Ser. No. 11/936,069, “Small-Pitch Three-Dimensional Mask-Programmable Memory”, filed Nov. 6, 2007.

Combining 3D-MM and 3D-mM, a 3D²-M² becomes an ultra-low-cost and ultra-large-capacity memory module. At the 50 nm node, a ×4 3D²-M² (which comprises four 3D-mM chips) can reach a storage capacity of ˜64 GB, enough to store ˜120 movies; and its movie storage cost is ˜0.4. This is comparable to DVD, whose movie storage cost is ˜0.2-$0.7. At the 17 nm node, a ×8 3D²-mM² can store ˜1 TB, enough to store ˜2,000 movies; and its movie storage cost is ˜0.05.

Referring now to FIG. 13, another preferred 3D²-M² system 50x is illustrated. Its UC block 54 is located in the mobile device 58. This way, the UC block 54 can share resources (e.g. uP, RAM, ROM) with the mobile device 58. In this preferred embodiment, the 3D²-M² 40 could comprise no UC block. To protect copyrights, at least a portion of the PML 52 is encrypted.

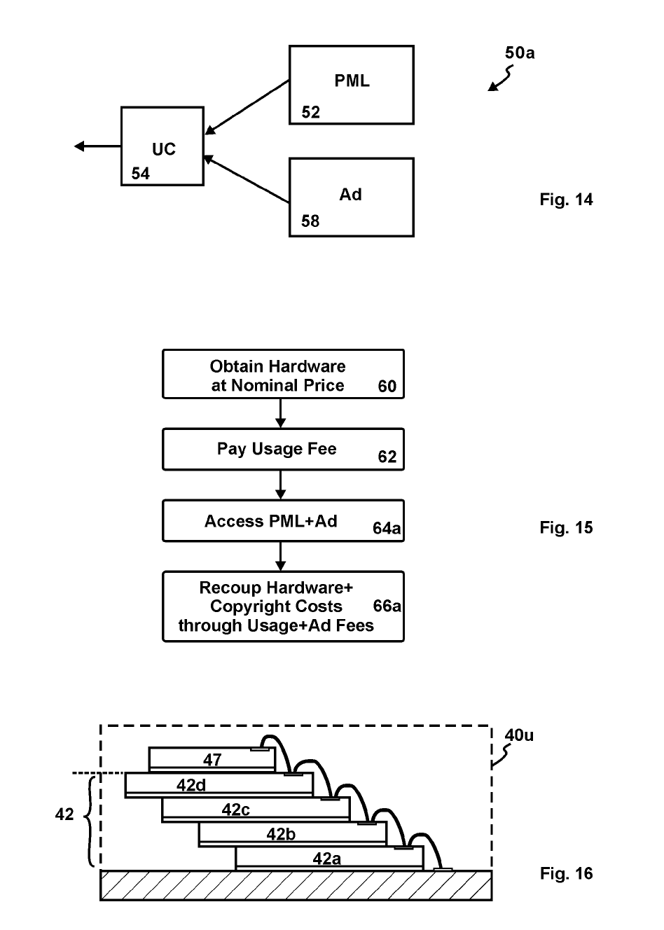

Referring now to FIG. 14, a preferred 3D²-M² system with advertisements 50a is illustrated. Besides the PML 52, it further contains advertisements 58. The UC block 54 controls which advertisements to play and when. A user will be charged a reduced usage fee if advertisement playback is accepted during content playback.

Referring now to FIG. 15, a preferred distribution model for the preferred 3D²-M² system with advertisements 50 is illustrated. During content playback, if advertisement playback is accepted, a user pays a reduced usage fee (step 64a). The hardware and copyright costs are recouped through both the usage and advertisement fees (step 66a). In an extreme case when enough advertisements are played back, a user could get the hardware for free, or even access the multimedia contents for free.

The pre-recorded multimedia contents stored in a 3D-mM cannot be altered after customer delivery. To update contents (including advertisements), a 3D²-M² system preferably comprises an electrically-programmable memory (EPM), e.g. flash memory. FIG. 16 illustrates a preferred 3D²-M² with updatability 40u. Besides the 3D-mM stack 42, it further comprises an EPM chip 47. This EPM chip 47 can be used to store updated contents, e.g. newly released movies, songs, books, and advertisements. These updated contents can be broadcasted to users, or downloaded by users. Note that the EPM 47 can also be located in the substrate 92 of the 3D-mM 90, or in the mobile device 58. It should be apparent to those skilled in the art that chip 47 may also comprise logic or analog functions. It can directly process the multimedia contents stored in the 3D-mM stack 42.

While illustrative embodiments have been shown and described, it would be apparent to those skilled in the art that may more modifications than that have been mentioned above are possible without departing from the inventive concepts set forth therein. For example, the 3D²-M²'s disclosed in the specification comprise two to four stacked 3D-mM chips. They can, in fact, comprise more 3D-mM chips. The invention, therefore, is not to be limited except in the spirit of the appended claims.

What is claimed is:

1. A three-dimensional-memory-based three-dimensional memory module (3D²-M²) system, comprising:
a three-dimensional memory module (3D-MM) comprising a plurality of vertically stacked three-dimensional mask-programmable memory (3D-mM) chips, each of said 3D-mM chip comprising a plurality of vertically stacked 3D-mM memory levels, wherein said 3D-mM chips store a pre-recorded multimedia library (PML); and
a usage-control block for controlling the usage of said PML.

2. The 3D²-M² system according to claim 1, wherein at least a portion of the contents in said PML is encrypted.

3. The 3D²-M² system according to claim 1, wherein said PML contains textual, audio, image, video, game, and/or software contents.

4. The 3D²-M² system according to claim 1, wherein said PML contains a pre-recorded movie library (PmL).

5. The 3D²-M² system according to claim 4, wherein said PmL contains at least tens of movies, preferably hundreds of movies.

6. The 3D²-M² system according to claim 4, wherein the movie storage cost of said 3D²-M² is comparable to DVD.

7. The 3D²-M² system according to claim 1, wherein said 3D-MM is an offset 3D-MM or a double-sided 3D-MM.

8. The 3D²-M² system according to claim 1, wherein at least one of said 3D-mM chips is N-ary 3D-mM (N>2), hybrid-level 3D-mM, and/or small-pitch 3D-mM.

9. The 3D²-M² system according to claim 1, wherein said usage-control block is located inside said 3D-MM.

10. The 3D²-M² system according to claim 1, further comprising a mobile device for playing selected contents in said PML.

11. The 3D²-M² system according to claim 10, wherein said mobile device is a cellular phone.

12. The 3D²-M² system according to claim 10, wherein said usage-control block is located in said mobile device.

13. The 3D²-M² system according to claim 1, wherein a user pays a usage fee for the selected usage.

14. The 3D²-M² system according to claim 13, wherein said user pays a nominal average selling price (ASP) for the hardware.

15. The 3D²-M² system according to claim 1, further containing advertisement(s), whereby a user pays a reduced usage fee when advertisement playback is allowed during content playback.

16. A three-dimensional-memory-based three-dimensional memory module (3D²-M²), comprising:
a three-dimensional memory module (3D-MM) comprising a plurality of vertically stacked three-dimensional mask-programmable memory (3D-mM) chips;
each of said 3D-mM chip comprising a plurality of vertically stacked 3D-mM memory levels;
wherein said 3D-mM chips store a pre-recorded multimedia library (PML), and at least a portion of the contents in said PML is encrypted.

17. The 3D²-M² according to claim 16, wherein said PML contains textual, audio, image, video, game, and/or software contents.

18. The 3D²-M² according to claim 16, wherein said PML contains a pre-recorded movie library (PmL).

19. A three-dimensional-memory-based three-dimensional memory module (3D²-M²), comprising:
a plurality of vertically stacked three-dimensional mask-programmable memory (3D-mM) chips, each of said 3D-mM chip comprising a plurality of vertically stacked 3D-mM memory levels, wherein said 3D-mM chips store a pre-recorded multimedia library (PML); and
an electrically-programmable memory for storing updated contents for said PML or advertisements.

20. The 3D²-M² according to claim 19, wherein said electrically-programmable memory is stacked with said 3D-mM chips.
